(19) United States
(12) Patent Application Publication
(10) Pub. No.: US 2026/0115808 A1
(43) Pub. Date: Apr. 30, 2026

(54) CUTTING TOOL

(71) Applicant: SUMITOMO ELECTRIC HARDMETAL CORP., Hyogo (JP)

(72) Inventors: Yuki HIRABUKI, Hyogo (JP); Mayuka SEGAWA, Hyogo (JP); Taisuke HIGASHI, Hyogo (JP); Satoru KUKINO, Hyogo (JP)

(73) Assignee: SUMITOMO ELECTRIC HARDMETAL CORP., Hyogo (JP)

(21) Appl. No.: 19/164,415

(22) PCT Filed: Mar. 27, 2024
(86) PCT No.: PCT/JP2024/012351

§ 371 Date: Sep. 11, 2025

(51) Int. Cl. B23B 27/14

(52) U.S. Cl. CPC B23B 27/148

(57) ABSTRACT

A cutting tool includes a main body and a cutting edge. The main body has a rod shape. The cutting edge layer is disposed at a front end of the main body. The cutting edge layer forms a cutting edge. The main body is formed of a cemented carbide containing tungsten carbide and cobalt. The cutting edge layer is formed of polycrystalline diamond. In the cemented carbide, a percentage of a value obtained by dividing a weight of the tungsten carbide by a weight of an entirety of the cemented carbide is 90.0% to 95.0%. In the cemented carbide, a percentage of a value obtained by dividing a weight of the cobalt by the weight of the entirety of the cemented carbide is 4.0% to 9.0%.

### TECHNICAL FIELD

The present disclosure relates to a cutting tool.

### BACKGROUND ART

Japanese Examined Utility Model Application Publication No. 59 (1984)-183301 (Patent Literature 1) discloses a boring tool in which a composite cutting edge tip is brazed in a tip seat disposed at a tip end of a tool body having a cylindrical shape.

### CITATION LIST

### Patent Literature

Patent Literature 1: Japanese Examined Utility Model Application Publication No. 59 (1984)-183301

### SUMMARY OF INVENTION

A cutting tool according to the present disclosure includes a main body and a cutting edge layer. The main body has a rod shape. The cutting edge layer is disposed at a front end of the main body. The cutting edge layer forms a cutting edge. The main body is formed of a cemented carbide containing tungsten carbide and cobalt. The cutting edge layer is formed of polycrystalline diamond. In the cemented carbide, a percentage of a value obtained by dividing a weight of the tungsten carbide by a weight of an entirety of the cemented carbide is 90.0% to 95.0%. In the cemented carbide, a percentage of a value obtained by dividing a weight of the cobalt by the weight of the entirety of the cemented carbide is 4.0% to 9.0%.

### BRIEF DESCRIPTION OF THE DRAWINGS

FIG. 1 is a schematic plan view showing a configuration of a cutting tool according to an embodiment.

FIG. 2 is an enlarged schematic view showing a region II in FIG. 1.

FIG. 3 is a schematic side face view showing the configuration of the cutting tool according to the embodiment.

FIG. 4 is a schematic front view showing the configuration of the cutting tool according to the embodiment.

FIG. 5 is a schematic sectional view taken along a line V-V in FIG. 1.

FIG. 6 is a schematic sectional view taken along a line VI-VI in FIG. 2.

FIG. 7 is a schematic view showing the configuration of the cutting tool as viewed in a direction in which the first cutting edge portion extends.

FIG. 8 is a schematic view showing the configuration of the cutting tool as viewed in a direction in which a second cutting edge portion extends.

FIG. 9 is a partial schematic sectional view for explaining a use state of the cutting tool according to the embodiment.

FIG. 10 is an enlarged schematic view showing a state in which a workpiece is being cut using the cutting tool according to the embodiment.

### DETAILED DESCRIPTION

### Problems to be Solved by Present Disclosure

When a workpiece is cut using a cutting tool, the main body of the cutting tool may vibrate. This may increase the surface roughness of the processed surface of the workpiece.

An object of the present disclosure is to provide a cutting tool capable of reducing the surface roughness of a processed surface of a workpiece.

### Advantageous Effects of Present Disclosure

According to the present disclosure, a cutting tool capable of reducing the surface roughness of a processed surface of a workpiece can be provided.

### Overview of Embodiment

First, an overview of embodiments of the present disclosure will be described.
(1) A cutting tool according to the present disclosure has a main body and a cutting edge layer. The main body has a rod shape. The cutting edge layer is disposed at a front end of the main body. The cutting edge layer forms a cutting edge. The main body is formed of a cemented carbide containing tungsten carbide and cobalt. The cutting edge layer is formed of polycrystalline diamond. In the cemented carbide, a percentage of a value obtained by dividing a weight of the tungsten carbide by a weight of an entirety of the cemented carbide is 90.0% to 95.0%. In the cemented carbide, a percentage of a value obtained by dividing a weight of the cobalt by the weight of the entirety of the cemented carbide is 4.0% to 9.0%. Thus, when the workpiece is processed, the vibration of the cutting tool can be reduced. This can reduce the surface roughness of the processed surface of the workpiece.
(2) According to the cutting tool of the above (1), in the cemented carbide, the percentage of the value obtained by dividing the weight of the cobalt by the weight of the entirety of the cemented carbide may be 5.0% to 8.0%. This can effectively reduce an excessive decrease in the transverse rupture strength of the main body. Thus, the main body can be effectively prevented from being broken.
(3) According to the cutting tool of the above (1) or (2), the polycrystalline diamond may include a plurality of diamond grains. In the polycrystalline diamond, a percentage of a value obtained by dividing a weight of a binder binding the plurality of diamond grains together by a weight of an entirety of the polycrystalline diamond may be 10.0% or less or 0%. This can improve the wear resistance of the cutting edge layer.
(4) According to the cutting tool of the above (3), in the polycrystalline diamond, the percentage of the value obtained by dividing the weight of the binder by the weight of the entirety of the polycrystalline diamond may be 1.0% or less or 0%. Thus, the wear resistance of the cutting edge layer can be effectively improved.
(5) According to the cutting tool of any one of the above (1) to (4), the main body may have a diameter of 6 mm or less. This makes it possible to perform inside diameter processing even when the inside diameter of the workpiece is relatively small.
(6) The cutting tool according to any one of the above (1) to (5) may include a brazing material. The brazing material may join the cutting edge layer and the main body together. The brazing material may contain silver, copper, and titanium. This can improve the rigidity of the entire cutting tool.
(7) According to the cutting tool of any one of the above (1) to (6), the cutting edge may have a corner cutting edge portion, a first cutting edge portion and a second cutting edge portion. The corner cutting edge portion may have a first end point and a second end point. The second end point may be located opposite to the first end point. The first cutting edge portion may be connected to the corner cutting edge portion at the first end point. The first cutting edge portion may be provided in a direction from the front end toward a rear end along an axis of the main body with respect to the corner cutting edge portion. The second cutting edge portion may be connected to the corner cutting edge portion at the second end point. The second cutting edge portion may be provided in a direction from the corner cutting edge portion toward the axis with respect to the corner cutting edge portion. The cutting edge layer may have a first flank face. When viewed in a direction in which the first cutting edge portion extends, the first flank face may be inclined, with respect to an imaginary straight line perpendicular to an imaginary plane including the corner cutting edge portion and the first cutting edge portion and crossing the first cutting edge portion, in a direction from the first cutting edge portion toward the axis, and an angle formed by the imaginary straight line and the first flank face may be 7° to 13°. When viewed in a direction perpendicular to the imaginary plane, the first cutting edge portion may be inclined with respect to the axis in a direction from the first end point toward the axis with the first end point serving as a fulcrum, and an angle formed by the axis and the first cutting edge portion may be 2° to 4°.

Thus, the surface roughness of the processed surface of the workpiece can be effectively reduced while reducing a decrease in the strength of the cutting edge.
(8) According to the cutting tool of the above (7), the cutting edge layer may have a second flank face. The second flank face may be connected to the first flank face. The second flank face may be located opposite to the first cutting edge portion with respect to the first flank face. When viewed in the direction in which the first cutting edge portion extends, the second flank face may be inclined with respect to the imaginary straight line in the direction from the first cutting edge portion toward the axis, and an angle formed by the imaginary straight line and the second flank face may be 20° or more. A width of the first flank face in a direction in which the imaginary straight line extends may be 0.4 mm or less. Thus, when the inside diameter processing is performed on a workpiece having a small inside diameter, it is possible to prevent the cutting edge layer and the workpiece from coming into contact with each other.

### Details of Embodiment

Hereinafter, details of the embodiment of the present disclosure (hereinafter, also referred to as the embodiment) will be described with reference to the drawings. In the drawings below, the same or corresponding parts are denoted by the same reference signs, and description thereof will not be repeated.

### <Configuration of Cutting Tool>

First, a configuration of a cutting tool 100 according to the embodiment will be described.

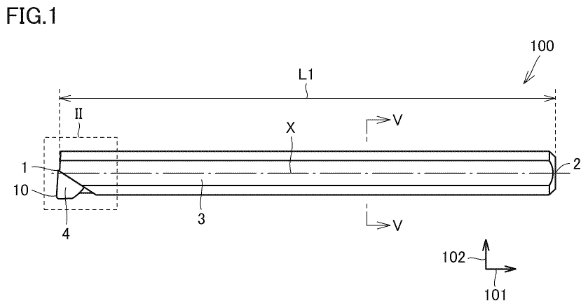

FIG. 1 is a schematic plan view showing the configuration of the cutting tool 100 according to the embodiment. The cutting tool 100 is a turning tool for turning a workpiece (not shown) by bringing a cutting edge 10 into contact with the rotating workpiece. Specifically, the cutting tool 100 is, for example, a boring tool. In other words, the cutting tool 100 is used for, for example, a process of enlarging the inside diameter of a workpiece. More specifically, the cutting tool 100 is used for, for example, processing for enlarging the inside diameter of a workpiece and processing with a relatively small depth of cut.

As shown in FIG. 1, the cutting tool 100 has a main body 3 and a cutting edge layer 4. The main body 3 has a rod shape. The main body 3 extends along an axis X. The main body 3 has a front end 1 and a rear end 2. The front end 1 is a portion facing the workpiece. The rear end 2 is a portion facing a machine tool (not shown) supporting the cutting tool 100.

The main body 3 extends in a direction from the front end 1 toward the rear end 2 along the axis X. In the present specification, the direction from the front end 1 to the rear end 2 along the axis X is also referred to as a first direction 101. A length L1 of the main body 3 in the first direction 101 is, for example, 30 mm or more. The main body 3 is formed of cemented carbide. The cemented carbide is a sintered material containing tungsten carbide grains as a main component. The specific composition of the cemented carbide forming the main body 3 will be described later.

The cutting edge layer 4 is disposed at the front end 1 of the main body 3. The cutting edge layer 4 forms the cutting edge 10. The cutting edge layer 4 is formed of polycrystalline diamond. A specific composition of the polycrystalline diamond forming the cutting edge layer 4 will be described later.

### <Composition of Cemented Carbide>

The cemented carbide forming the main body 3 contains tungsten carbide (WC) and cobalt (Co). The cemented carbide includes a hard phase and a binder phase. The hard phase is substantially constituted of WC grains. The binder phase binds the WC grains to each other. The binder phase contains Co and the like. In the present specification, the percentage of the value obtained by dividing the weight of a component contained in a certain substance by the weight of the entire substance is referred to as the content rate of the component in the substance.

The content rate of WC (WC content rate) in the cemented carbide forming the main body 3 is 90.0% to 95.0%. The WC content rate may be, for example, 91.0% or more, or may be 93.0% or more. The WC content rate may be, for example, 94.7% or less, or may be 94.3% or less.

The content rate of Co (Co content rate) in the cemented carbide forming the main body 3 is 4.0% to 9.0%. The Co content rate may be, for example, 5.0% to 8.0%, or may be 5.0% to 7.0%. The Co content rate may be, for example, 4.3% or more, or may be 4.7% or more. The Co content rate may be, for example, 8.5% or less, 7.5% or less, or may be 6.5% or less.

The value obtained by adding the content rate of WC and the content rate of Co may be, for example, 98% or more, or may be 99% or more. The value obtained by adding the content rate of WC and the content rate of Co may be 100%, or may be less than 100%. From another viewpoint, the cemented carbide forming the main body 3 may contain components other than WC and Co. The binder phase may contain, for example, TiC (titanium carbide), TaC (tantalum carbide), NbC (niobium carbide), or the like. The cemented carbide forming the main body 3 may contain inevitable impurities.

### <Composition of Polycrystalline Diamond>

The polycrystalline diamond forming the cutting edge layer 4 includes a plurality of diamond grains. The polycrystalline diamond forming the cutting edge layer 4 may be polycrystalline sintered diamond (PCD: Poly-Crystalline Diamond) or binderless polycrystalline diamond (hereinafter also referred to as BLPCD).

The PCD is composed of, for example, a binder and a plurality of diamond grains. The BLPCD is polycrystalline diamond in which a plurality of diamond grains are bound without a binder. In other words, the BLPCD does not contain a binder. The binder is made of Co. The binder may contain inevitable impurities such as TiC in addition to Co. The polycrystalline diamond forming the cutting edge layer 4 may be nano polycrystalline diamond. The nano polycrystalline diamond refers to polycrystalline diamond in which a plurality of diamond grains have grain sizes of a nanometer order.

The content rate of the binder (binder content rate) in the polycrystalline diamond forming the cutting edge layer 4 is, for example, 0%. When the polycrystalline diamond is BLPCD, the binder content rate is 0%. From another viewpoint, the polycrystalline diamond may be constituted of a plurality of diamond grains and inevitable impurities.

The binder content rate may be 10.0% or less. The binder content rate may be, for example, 0.01% or more, or may be 0.1% or more. The binder content rate may be, for example, 5.0% or less, 1.0% or less, or 0.5% or less.

Each of the WC content rate, the Co content rate, and the binder content rate can be measured by the following measurement method using an energy dispersive X-ray spectroscopy (EDX) attached to a field emission scanning electron microscope (FE-SEM). As the FE-SEM and the EDX, for example, Gemini450 manufactured by ZEISS and Ultim Max manufactured by Oxford Instruments can be used.

When the WC content rate and the Co content rate are measured, first, the main body 3 is embedded in a resin. The main body 3 is cut to expose a cross section of the main body 3. Subsequently, the exposed cross section is polished to prepare a polished surface for observation. Any five locations (five fields of view) on the polished surface for observation are observed at a magnification of 3000 times using EDX, and elemental analysis is performed. Thus, the value of the content rate (weight %) of each element is determined. By obtaining the average value of the values of the five fields of view for each element, the composition of the cemented carbide forming the main body 3 can be specified. The WC content rate and the Co content rate are determined using the identified composition of the cemented carbide. As the resin for filling the main body 3, a thermosetting resin or the like can be used.

The cross section of the main body 3 can be polished by a conventionally known method. For example, a smoothed polished surface for observation can be obtained by subjecting the cross section of the main body 3 to ion milling treatment using argon ions. The conditions of the ion milling treatment with Ar ions are, for example, as follows.
Acceleration voltage: 6 kV
Irradiation angle: 0° to 5° from a plane parallel to the cross section of the main body 3
Irradiation time: 6 hours.

Similarly, in the case of measuring the binder content rate, the composition of the polycrystalline diamond forming the cutting edge layer 4 can be specified by using the above-described measurement method for the cutting edge layer 4. The binder content rate is determined using the specified composition of the polycrystalline diamond. Specifically, the content rate of Co in polycrystalline diamond can be used as the binder content rate.

### <More Specific Configuration of Cutting Tool>

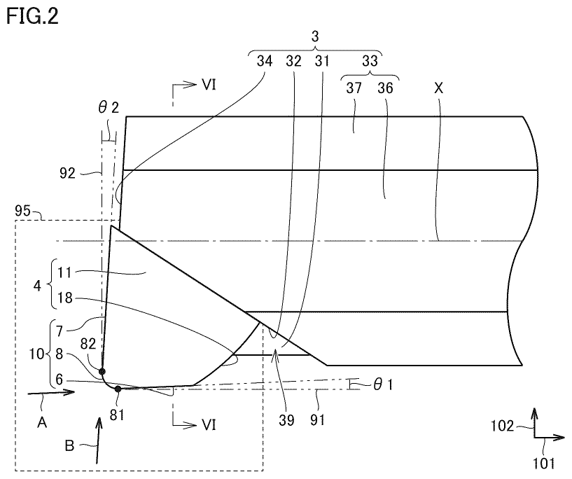

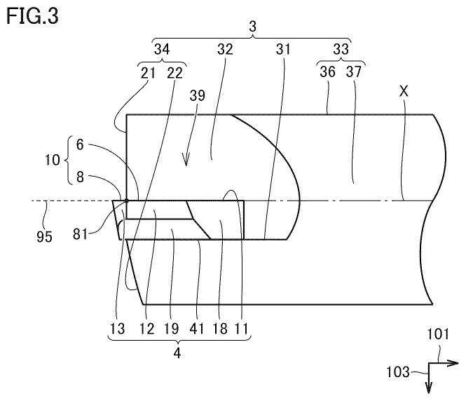

FIG. 2 is an enlarged schematic view showing a region II of FIG. 1. FIG. 3 is a side face schematic view showing the configuration of the cutting tool 100 according to the embodiment. As shown in FIG. 2 and FIG. 3, the main body 3 has a seat face 31, a sidewall face 32, an outer peripheral face 33, and a front end face 34.

The seat face 31 is, for example, planar. The sidewall face 32 is connected to the seat face 31. The sidewall face 32 is perpendicular to the seat face 31, for example. The seat face 31 and the sidewall face 32 form a depression 39. The cutting edge layer 4 is arranged in the depression 39.

The outer peripheral face 33 has a flat face portion 36 and a curved face portion 37. The flat face portion 36 is planar. The flat face portion 36 is parallel to the seat face 31, for example. The flat face portion 36 is connected to the sidewall face 32. The curved face portion 37 is connected to each of the seat face 31 and the sidewall face 32.

The front end face 34 is located at the front end 1 of the main body 3. The front end face 34 is connected to each of the seat face 31, the sidewall face 32, the flat face portion 36, and the curved face portion 37.

As shown in FIG. 2, the cutting edge 10 has a corner cutting edge portion 8, a first cutting edge portion 6, and a second cutting edge portion 7. The corner cutting edge portion 8 is provided in a direction opposite to the first direction 101 with respect to the main body 3. The corner cutting edge portion 8 has a first end point 81 and a second end point 82. In the corner cutting edge portion 8, the second end point 82 is located opposite to the first end point 81. The first end point 81 is located in the first direction 101 with respect to the second end point 82. At the first end point 81, the first cutting edge portion 6 is connected to the corner cutting edge portion 8. The first cutting edge portion 6 is provided in the first direction 101 with respect to the corner cutting edge portion 8.

In FIG. 2, a dashed line indicates an imaginary plane 95. The imaginary plane 95 includes the first cutting edge portion 6 and the corner cutting edge portion 8. From another point of view, the first cutting edge portion 6 and the corner cutting edge portion 8 are, for example, substantially coplanar. The imaginary plane 95 may include the axis X. In FIG. 2, the configuration of the cutting tool 100 is shown as viewed perpendicular to the imaginary plane 95. When viewed in a direction perpendicular to the imaginary plane 95, the direction from the first end point 81 toward the axis X is a second direction 102. The second direction 102 is perpendicular to the axis X. The imaginary plane 95 extends along, for example, each of the first direction 101 and the second direction 102.

As shown in FIG. 2, when viewed in a direction perpendicular to the imaginary plane 95, the corner cutting edge portion 8 is curved. When viewed in a direction perpendicular to the imaginary plane 95, the corner cutting edge portion 8 may be, for example, arc-shaped. When viewed in a direction perpendicular to the imaginary plane 95, the curvature radius of the corner cutting edge portion 8 is, for example, 0.05 mm to 0.5 mm.

As shown in FIG. 2, the first cutting edge portion 6 is, for example, linear. When viewed in a direction perpendicular to the imaginary plane 95, the first cutting edge portion 6 is inclined in the second direction 102 with respect to the axis X with the first end point 81 serving as a fulcrum. From another point of view, when viewed in a direction perpendicular to the imaginary plane 95, the distance between the first cutting edge portion 6 and the axis X decreases as the distance from the first end point 81 increases. A first imaginary straight line 91 shown in FIG. 2 is a straight line parallel to the axis X.

When viewed in a direction perpendicular to the imaginary plane 95, the inclination angle of the first cutting edge portion 6 with respect to the axis X is defined as a first angle θ1. The first angle θ1 is, for example, 2° to 4°. The first angle θ1 may be, for example, 2.3° or more, or 2.7° or more. The first angle θ1 may be, for example, 3.7° or less, or 3.3° or less.

The first cutting edge portion 6 is provided in a direction opposite to the second direction 102 with respect to the outer peripheral face 33 of the main body 3. In the second direction 102, the first cutting edge portion 6 is provided between the outer peripheral face 33 and the first end point 81.

The second cutting edge portion 7 is provided in the second direction 102 with respect to the corner cutting edge portion 8. From another viewpoint, the second cutting edge portion 7 is provided in a direction from the corner cutting edge portion 8 toward the axis X. At the second end point 82, the second cutting edge portion 7 is connected to the corner cutting edge portion 8. From another viewpoint, in the cutting edge 10, the corner cutting edge portion 8 is between the first cutting edge portion 6 and the second cutting edge portion 7.

The second cutting edge portion 7 is, for example, linear. When viewed in a direction perpendicular to the imaginary plane 95, the second cutting edge portion 7 is inclined in the first direction 101 with respect to a second imaginary straight line 92 with the second end point 82 as a fulcrum. The second imaginary straight line 92 is a straight line perpendicular to the axis X when viewed in a direction perpendicular to the imaginary plane 95.

When viewed in a direction perpendicular to the imaginary plane 95, the inclination angle of the second cutting edge portion 7 with respect to the second imaginary straight line 92 is defined as a second angle θ2. The second angle θ2 is, for example, 3°. The second angle θ2 may be, for example, 2° to 4°.

When viewed in a direction perpendicular to the imaginary plane 95, the front end face 34 of the main body 3 may be substantially parallel to the second cutting edge portion 7. The front end face 34 is located in the first direction 101 with respect to the second cutting edge portion 7. In the first direction 101, the second cutting edge portion 7 is provided between the front end face 34 and the second end point 82.

As shown in FIG. 2, the cutting edge layer 4 has a rake face 11 and a curved face 18. The rake face 11 is connected to the cutting edge 10. Specifically, the rake face 11 is connected to each of the corner cutting edge portion 8, the first cutting edge portion 6, and the second cutting edge portion 7. The rake face 11 is, for example, planar. The rake face 11 extends along, for example, the imaginary plane 95. The curved face 18 is connected to the rake face 11. When viewed in a direction perpendicular to the imaginary plane 95, the curved face 18 has, for example, arc-shaped.

As shown in FIG. 3, the cutting edge layer 4 has a bottom face 41, a first flank face 12, a second flank face 19, and a corner flank face 13. The bottom face 41 is located opposite to the rake face 11. A direction that is perpendicular to the imaginary plane 95 and that is directed from the rake face 11 toward the bottom face 41 is defined as a third direction 103.

The first flank face 12 is connected to the first cutting edge portion 6. The first cutting edge portion 6 is formed by the ridge line between the first flank face 12 and the rake face 11. The first flank face 12 is provided in the third direction 103 with respect to the rake face 11. The second flank face 19 is connected to each of the first flank face 12 and the bottom face 41. The second flank face 19 is provided in the third direction 103 with respect to the first flank face 12. From another point of view, the second flank face 19 is located opposite to the first cutting edge portion 6 with respect to the first flank face 12. In the third direction 103, the second flank face 19 is provided between the first flank face 12 and the bottom face 41.

The corner flank face 13 is connected to the corner cutting edge portion 8. The corner cutting edge portion 8 is formed by the ridge line between the corner flank face 13 and the rake face 11. The corner flank face 13 is connected to each of the first flank face 12 and the second flank face 19. The curved face 18 is connected to each of the rake face 11, the first flank face 12, the second flank face 19, and the bottom face 41.

As shown in FIG. 3, the front end face 34 has a first front end face portion 21 and a second front end face portion 22. The first front end face portion 21 is connected to the flat face portion 36. When viewed in the second direction 102, the first front end face portion 21 extends along the third direction 103. The second front end face portion 22 is provided in the third direction 103 with respect to the first front end face portion 21. When viewed in the second direction 102, the second front end face portion 22 is inclined in the first direction 101 with respect to the first front end face portion 21. It is noted that FIG. 3 shows the configuration of the cutting tool 100 as viewed in the second direction 102.

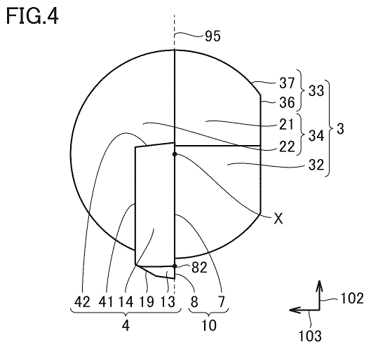

FIG. 4 is a schematic front view showing the configuration of the cutting tool 100 according to the embodiment. In FIG. 4, the configuration of the cutting tool 100 as viewed in the first direction 101 is shown. As shown in FIG. 4, the cutting edge layer 4 has a third flank face 14 and a side face 42. The third flank face 14 is connected to the corner flank face 13, the bottom face 41, and the second cutting edge portion 7.

The third flank face 14 is provided in the third direction 103 with respect to the second cutting edge portion 7. The second cutting edge portion 7 is formed by the ridge line between the third flank face 14 and the rake face 11 (see FIG. 2 and FIG. 3). The side face 42 is connected to each of the third flank face 14, the bottom face 41, and the rake face 11 (see FIG. 2 and FIG. 3).

As shown in FIG. 4, when viewed in the axis X, the second cutting edge portion 7 may be parallel to the second direction 102. When viewed in the axis X, the corner cutting edge portion 8 may be linear. When viewed in the axis X, the corner cutting edge portion 8 may be parallel to the second direction 102. The bottom face 41 may be parallel to imaginary plane 95, for example. When viewed in the axis X, the curved face portion 37 of the main body 3 is, for example, arc-shaped. The flat face portion 36 of the main body 3 is parallel to the second direction 102, for example. The second front end face portion 22 is connected to the first front end face portion 21.

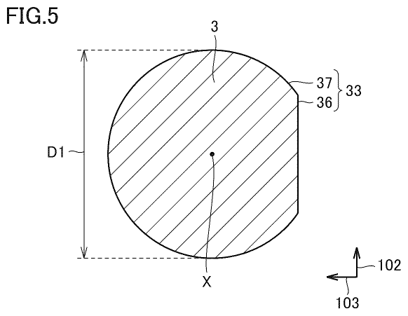

FIG. 5 is a schematic sectional view taken along line V-V in FIG. 1. The cross section shown in FIG. 5 is a cross section perpendicular to the axis X. As shown in FIG. 5, the main body 3 has a cylindrical outer shape, for example. In the present specification, the term “cylindrical” refers to a shape including an arc having a central angle of 180° or more at the outer edge of the cross-sectional shape. Specifically, for example, the cylindrical shape includes a case where the cross-sectional shape is circular and a case where the outer edge of the cross-sectional shape is formed by an arc having a central angle of 180° or more and a straight line.

The axis X passes through the center of the main body 3. Specifically, in the cross section perpendicular to the axis X, the axis X is located at the center of a circle including an arc along the curved face portion 37, for example. A diameter D1 of the main body 3 is, for example, 6 mm or less. When the main body 3 has a cylindrical shape, the diameter D1 is the longest linear distance between two different points on the curved face portion 37 in the cross section perpendicular to the axis X. In other words, the diameter D1 is the maximum diameter of the main body 3.

The diameter D1 may be, for example, 5 mm or less, 4 mm or less, or 3 mm or less. The diameter D1 may be, for example, 1 mm or more, or may be 2 mm or more. A value obtained by dividing the length L1 (see FIG. 1) of the main body 3 in the first direction 101 by the diameter D1 is, for example, three or more.

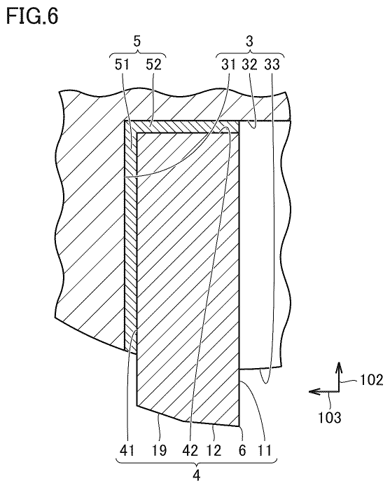

FIG. 6 is a schematic sectional view taken along a line VI-VI in FIG. 2. The cross section shown in FIG. 6 is a cross section perpendicular to the axis X and crossing each of the main body 3 and the cutting edge layer 4. As shown in FIG. 6, the cutting tool has a brazing material 5.

The brazing material 5 joins the cutting edge layer 4 and the main body 3 together. The brazing material 5 is located between the cutting edge layer 4 and the main body 3. The brazing material 5 contains, for example, silver, copper, and titanium. The brazing material 5 has a first portion 51 and a second portion 52.

In the third direction 103, the first portion 51 is provided between the bottom face 41 of the cutting edge layer 4 and the seat face 31 of the main body 3. The first portion 51 is in contact with each of the bottom face 41 and the seat face 31. The first portion 51 extends along each of the second direction 102 and the first direction 101 (see FIG. 2). In a cross section perpendicular to the axis X and crossing each of the main body 3 and the cutting edge layer 4, the seat face 31 is covered with the first portion 51.

The second portion 52 is connected to the first portion 51. The second portion 52 is provided between the side face 42 of the cutting edge layer 4 and the sidewall face 32 of the main body 3. The second portion 52 is in contact with the side face 42 of the cutting edge layer 4 and the sidewall face 32 of the main body 3. The second portion 52 extends along each of the third direction 103 and the first direction 101. In a cross section perpendicular to the axis X and crossing each of the main body 3 and the cutting edge layer 4, the side face 42 is covered with the second portion 52.

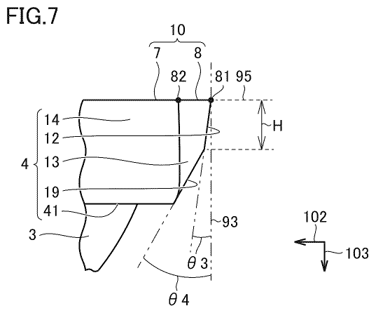

FIG. 7 is a schematic view showing the configuration of the cutting tool 100 as viewed in the direction in which the first cutting edge portion 6 extends. In FIG. 7, the configuration of the cutting tool 100 is shown as viewed in an arrow A shown in FIG. 2. The arrow A is a direction from the first end point 81 toward the rear end 2 (see FIG. 2) along the direction in which the first cutting edge portion 6 extends. In FIG. 7, a third imaginary straight line 93 is shown. The third imaginary straight line 93 is perpendicular to the imaginary plane 95. The third imaginary straight line 93 crosses the first cutting edge portion 6. From another point of view, when viewed in the direction in which the first cutting edge portion 6 extends, the third imaginary straight line 93 passes through the first end point 81.

As shown in FIG. 7, when viewed in the direction in which the first cutting edge portion 6 extends, the first flank face 12 is inclined in the second direction 102 with respect to the third imaginary straight line 93. From another point of view, the first flank face 12 is parallel to the imaginary plane 95 and inclined in a direction from the first cutting edge portion 6 (see FIG. 2) toward the axis X (see FIG. 2).

When viewed in the direction in which the first cutting edge portion 6 extends, the angle formed by the third imaginary straight line 93 and the first flank face 12 is defined as a third angle θ3. The third angle θ3 is, for example, 7° to 13°. The third angle θ3 may be, for example, 9° or more, or may be 11° or more. The third angle θ3 may be, for example, 12.5° or less, or may be 12° or less.

As shown in FIG. 7, when viewed in the direction in which the first cutting edge portion 6 extends, the second flank face 19 is inclined in the second direction 102 with respect to the third imaginary straight line 93. From another point of view, when viewed in the direction in which the first cutting edge portion 6 extends, the second flank face 19 is inclined with respect to the third imaginary straight line 93 in a direction parallel to the imaginary plane 95 and from the first cutting edge portion 6 (see FIG. 2) toward the axis X (see FIG. 2).

When viewed in the direction in which the first cutting edge portion 6 extends, the angle formed by the third imaginary straight line 93 and the second flank face 19 is defined as a fourth angle θ4. The fourth angle θ4 is larger than the third angle θ3. From another point of view, when viewed in the direction in which the first cutting edge portion 6 extends, the second flank face 19 is inclined in the second direction 102 with respect to the first flank face 12.

The fourth angle θ4 is, for example, 20° or more. The fourth angle θ4 may be, for example, 25° or more, or may be 30° or more. The fourth angle θ4 may be, for example, 50° or less, or may be 45° or less.

A width H of the first flank face 12 in a direction in which the third imaginary straight line 93 extends is 0.4 mm or less. The direction in which the third imaginary straight line 93 extends is the same as the third direction 103. For example, the width H may be 0.35 mm or less, or may be 0.3 mm or less. For example, the width H may be 0.1 mm or more, or may be 0.15 mm or more.

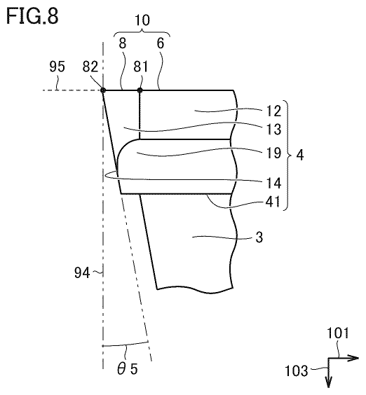

FIG. 8 is a schematic view showing the configuration of the cutting tool 100 as viewed in the direction in which the second cutting edge portion 7 extends. In FIG. 8, the configuration of the cutting tool 100 is shown as viewed in an arrow B shown in FIG. 2. The arrow B is a direction from the second end point 82 toward the axis X (see FIG. 2) along the direction in which the second cutting edge portion 7 extends. In FIG. 8, a fourth imaginary straight line 94 is shown. The fourth imaginary straight line 94 is perpendicular to the imaginary plane 95. The fourth imaginary straight line 94 crosses the second cutting edge portion 7. From another point of view, when viewed in the direction in which the second cutting edge portion 7 extends, the fourth imaginary straight line 94 passes through the second end point 82.

As shown in FIG. 8, when viewed in the direction in which the second cutting edge portion 7 extends, the third flank face 14 is inclined in the first direction 101 with respect to the fourth imaginary straight line 94. When viewed in the direction in which the second cutting edge portion 7 extends, the angle formed by the fourth imaginary straight line 94 and the third flank face 14 is defined as a fifth angle θ5. The fifth angle θ5 is, for example, 7° to 13°.

### <Use State of Cutting Tool>

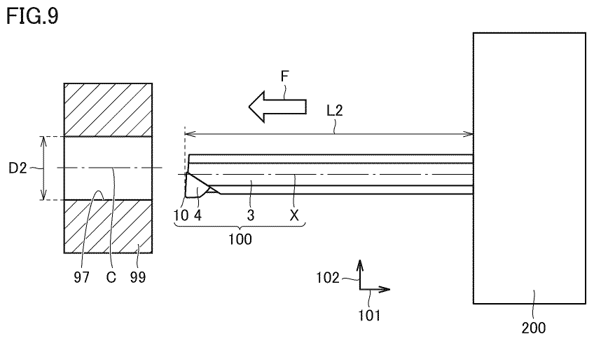

Next, an example of a use state of the cutting tool 100 according to the embodiment will be described. FIG. 9 is a partial schematic sectional view for explaining a use state of the cutting tool 100 according to the embodiment. As shown in FIG. 9, the cutting tool 100 is attached to a machine tool 200. Specifically, the cutting tool 100 is supported by the machine tool 200 by the portion of the main body 3 including the rear end 2 being gripped by the machine tool 200.

The length of the portion of the cutting tool 100 protruding from the machine tool 200 in the first direction 101 is an overhang length L2. The overhang length L2 is, for example, 12 mm or more.

A workpiece 99 is prepared. The workpiece 99 is formed of, for example, cemented carbide. An inner peripheral surface 97 of the workpiece 99 is a surface to be cut by using the cutting tool 100. An inside diameter D2 of the inner peripheral surface 97 is, for example, 7 mm or less. A value (L/D) obtained by dividing the overhang length L2 by the inside diameter D2 is, for example, three or more.

In the processing of the workpiece 99, the workpiece 99 rotates around a central axis C of the inner peripheral surface 97. The rotation direction of the workpiece 99 is, for example, clockwise as viewed in the first direction 101. In the second direction 102, the axis X of the cutting tool 100 is located between the central axis C and the inner peripheral surface 97. The cutting tool 100 is moved along arrow F. The arrow F is a direction opposite to the first direction 101. Thus, the cutting edge 10 is in contact with the workpiece 99 in a state in which the workpiece 99 is rotated.

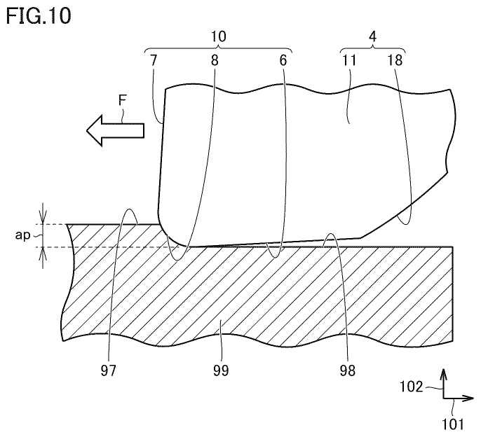

FIG. 10 is an enlarged schematic view showing a state in which the workpiece 99 is being cut using the cutting tool 100 according to the embodiment. As shown in FIG. 10, the corner cutting edge portion 8 is used to cut the workpiece 99. This forms a processed surface 98. A depth of cut ap of the cutting tool 100 is, for example, 0.1 mm or less. The first cutting edge portion 6 is in contact with the processed surface 98. Thus, the processed surface 98 is finished using the first cutting edge portion 6 while the workpiece 99 is cut using the corner cutting edge portion 8. In this way, the processing for enlarging the inside diameter D2 of the workpiece 99 is performed.

Next, effects of the cutting tool 100 according to the embodiment will be described. When cutting the workpiece, the surface roughness of the processed surface of the workpiece may become excessively large. In this case, after the cutting, for example, the processed surface is polished. Thus, the time required for processing the workpiece is increased. Thus, in the case of cutting the workpiece, it is required to reduce the surface roughness of the processed surface. In particular, when the workpiece is a mold made of cemented carbide, it is required to reduce the surface roughness of the processed surface after cutting.

The cutting tool 100 according to the embodiment has the main body 3 and the cutting edge layer 4. The cutting edge layer 4 forms the cutting edge 10. The main body 3 is formed of cemented carbide containing WC and Co. In the cemented carbide forming the main body 3, the content rate of WC is 90.0% to 95.0%. The content rate of Co in the cemented carbide forming the main body 3 is 4.0% to 9.0%.

When the Co content rate is 9.0% or less and the WC content rate is 90.0% or more, the rigidity of the main body 3 can be improved. Thus, when the workpiece is processed, the vibration of the cutting tool 100 can be reduced. This allows the processed surface of the workpiece to be smooth. Specifically, the surface roughness of the processed surface of the workpiece can be reduced.

According to the cutting tool 100 of the embodiment, the Co content rate is 4.0% or more, and thus it is possible to reduce an excessive decrease in the transverse rupture strength of the main body 3. Thus, even when a relatively high load is applied to the cutting tool 100 during processing of the workpiece 99, the main body 3 can be prevented from being broken.

When a workpiece, for example, a cemented carbide die, is processed using a cutting tool having a cutting edge formed of polycrystalline diamond, a portion of the cutting tool close to the cutting edge may be excessively worn due to the relatively high hardness of cemented carbide. In this case, the shape of the cutting edge may be deformed. Thus, it may be difficult to process the workpiece for a relatively long time.

According to the cutting tool 100 in the present embodiment, the content rate of the binder in the polycrystalline diamond forming the cutting edge layer 4 is 10.0% or less or 0%. Thus, the hardness of the cutting edge layer 4 can be improved. Thus, the wear resistance of the cutting edge layer 4 can be improved. This makes it possible to reduce wear of the cutting edge layer 4 even when the workpiece is formed of a relatively hard material such as cemented carbide. Thus, the workpiece can be processed in a relatively long time.

With the motorization of automobiles, there is an increasing demand for small-diameter screws. Thus, in the manufacture of the mold, it is required to perform the inside diameter processing of the small diameter by using the cutting. In the inside diameter processing of a small diameter, since the diameter of the cutting tool is small, it is difficult to achieve both reduction of vibration of the cutting tool and prevention of breakage of the cutting tool.

According to the cutting tool 100 of the embodiment, the main body 3 has the diameter D1 of 6 mm or less. This makes it possible to perform inside diameter processing even when the inside diameter of the workpiece is relatively small. Further, according to the cutting tool 100 of the embodiment, even when the diameter D1 of the main body 3 is relatively small as described above, the vibration of the cutting tool 100 can be sufficiently reduced and the breakage of the main body 3 can be prevented as described above.

The cutting tool 100 according to the embodiment has the brazing material 5. The brazing material 5 joins the main body 3 and the cutting edge layer 4 together. The brazing material 5 contains silver, copper, and titanium. Thus, the strength of the brazing material 5 can be improved. Thus, the rigidity of the entire cutting tool 100 can be improved. Thus, when the workpiece is processed, the vibration of the cutting tool 100 can be reduced. This allows for the effective reduction of the surface roughness of the processed surface of the workpiece.

According to the cutting tool 100 of the embodiment, when viewed in a direction perpendicular to the imaginary plane 95, the first cutting edge portion 6 is inclined in the second direction 102 with respect to the axis X with the first end point 81 serving as a fulcrum. At the first end point 81, the first cutting edge portion 6 is connected to the corner cutting edge portion 8. When viewed in a direction perpendicular to the imaginary plane 95, an angle (first angle θ1) formed by the axis X and the first cutting edge portion 6 is 2° to 4°. When the first angle θ1 is 4° or less, it is possible to reduce an excessive decrease in the strength of the cutting edge 10. As the first angle θ1 is 2° or more, the processed surface of the workpiece can be finished using the first cutting edge portion 6. As a result, the surface roughness of the processed surface of the workpiece can be effectively reduced.

According to the cutting tool 100 of the embodiment, the cutting edge layer 4 has the first flank face 12. The first flank face 12 is connected to the first cutting edge portion 6. When viewed in the direction in which the first cutting edge portion 6 extends, an angle (third angle θ3) formed by an imaginary straight line perpendicular to the imaginary plane 95 and the first flank face 12 is 7° to 13°. When the third angle θ3 is 7° or more, excessive rubbing between the first flank face 12 and the workpiece can be reduced. When the third angle θ3 is 13° or less, it is possible to reduce an excessive decrease in the strength of the cutting edge 10.

According to the cutting tool 100 of the embodiment, the cutting edge layer 4 has the second flank face 19. The second flank face 19 is connected to the first flank face 12. When viewed in the first cutting edge portion 6, an angle formed by an imaginary straight line perpendicular to the imaginary plane 95 and the second flank face 19 is 20° or more. The width of the first flank face 12 in a direction in which an imaginary straight line perpendicular to the imaginary plane 95 extends is 0.4 mm or less. Thus, when the inside diameter processing is performed on a workpiece having a small inside diameter, it is possible to prevent the cutting edge layer 4 and the workpiece from coming into contact with each other. To be specific, for example, when inside diameter processing is performed on a workpiece having an inside diameter 6 mm or less, it is possible to prevent the cutting edge layer 4 and the workpiece from coming into contact with each other.

Although the configuration in which the main body 3 has a cylindrical shape has been described above, the configuration of the cutting tool 100 according to the present disclosure is not limited to the above configuration. Specifically, the main body 3 may have a prismatic shape. From another viewpoint, the outer peripheral face 33 may have a polygonal shape in a cross section perpendicular to the axis X. When the main body 3 has a prismatic shape, the diameter D1 of the main body 3 is the diameter of the circumscribed circle of the outer peripheral face 33 in the cross section perpendicular to the axis X.

In the above description, the configuration in which the main body 3 and the cutting edge layer 4 are joined by the brazing material 5 has been described, but the cutting tool 100 according to the present disclosure does not necessarily have the brazing material 5. Specifically, the cutting tool 100 may be a throwaway tool. The main body 3 and the cutting edge layer 4 may be fastened to each other by, for example, a screw.

### Example 1

The present disclosure will be described in more detail with reference to examples, but the present disclosure is not limited thereto.

### <Sample Preparation>

First, the influence of the composition of the main body 3 on the surface roughness of the processed surface of the workpiece was investigated. The cutting tools 100 according to samples 1-1 to 1-5 were prepared. The cutting tool 100 according to samples 1-1 to 1-3 were examples. The cutting tool 100 according to samples 1-4 and 1-5 were comparative examples.

In the manufacture of cutting tools 100 according to samples 1-1 to 1-5, polycrystalline diamond was prepared first. The thickness of the polycrystalline diamond was 0.65 mm. The shape of the polycrystalline diamond was a sector shape having a central angle of 60° and a radius of 3 mm.

The polycrystalline diamond and the main body 3 were joined by the brazing material 5. The cutting edge layer 4 was formed by processing polycrystalline diamond using laser processing. The cutting tools 100 according to samples 1-1 to 1-5 were prepared as described above.

TABLE 1

| | Material of Main Body | | | | |
|---|---|---|---|---|---|
| | WC | Co | Diameter | | |
| | Content | Content | of Main | | |
| | Rate | Rate | Body | First | Third |
| | (%) | (%) | (mm) | Angle | Angle |
| Sample 1-1 | 92 | 8 | 3.5 | 3° | 10° |
| Sample 1-2 | 94 | 5 | | | |
| Sample 1-3 | 94 | 5.4 | | | |
| Sample 1-4 | 88 | 12 | | | |
| Sample 1-5 | 89 | 6 | | | |

Table 1 shows the configuration of the cutting tool 100 according to samples 1-1 to 1-5. As shown in table 1, in samples 1-1 to 1-3, the WC content rate was 92% to 94%. The Co content rate was 5% to 8%. In the samples 1-4 and 1-5, the WC content rate was 89% or less. In sample 1-4, the Co content rate was 12%. In the sample 1-5, the Co content rate was 6%.

In samples 1-1 to 1-5, the cutting edge layer 4 was formed of nano polycrystalline diamond. The binder content rate of the polycrystalline diamond forming the cutting edge layer 4 was 0%. The diameter of the main body 3 was 3.5 mm. The first angle θ1 was 3°. The clearance angle (third angle θ3) was 10°.

### <Evaluation Method>

The following cutting evaluation was performed using the cutting tools 100 according to samples 1-1 to 1-5. Specifically, the cutting tool 100 was attached to the turret of a numerical control (NC) lathe. A cylindrical workpiece was fixed to the chuck of an NC lathe. Turning was performed on the workpiece using the following cutting conditions. In the following description, HRA means Rockwell hardness A scale.

### <Cutting Conditions>

Workpiece: Cemented carbide (hardness: HRA88.0, outside diameter: 30 mm, inside diameter: 5 mm, total length: 18 mm)
Cutting speed (Vc): 10 m/min
Depth of cut (ap): 0.025 mm
Feed per revolution (f): 0.04 mm/rev
Overhang length: 20 mm
Cutting oil material: None (dry processing)

In the turning, the maximum height roughness Rz and the arithmetic average roughness Ra of the processed surfaces of the workpieces were measured at the time when the cut length reached 5.6 m. Rz and Ra were measured in accordance with JIS (Japanese Industrial Standards) B 0601:2001 using a surface roughness measuring device. It is understood that the smaller the numerical values of Rz and Ra, the smoother the processed surface of the workpiece can be finished by the sample.

### <Evaluation Result>

TABLE 2

Surface Roughness of
Processed Surface

| | Rz | Ra |
|---|---|---|
| | (μm) | (μm) |
| Sample 1-1 | 1.832 | 0.336 |
| Sample 1-2 | 1.408 | 0.246 |
| Sample 1-3 | 1.545 | 0.337 |
| Sample 1-4 | 2.397 | 0.456 |
| Sample 1-5 | 2.258 | 0.431 |

Table 2 shows the evaluation results of samples 1-1 to 1-5. As shown in table 2, in samples 1-1 to 1-3, Rz of the processed surface was 1.832 μm or less. Ra of the processed surface was 0.337 μm or less. In samples 1-4 and 1-5, the Rz of the processed surface was 2.258 μm or more. Ra of the processed surface was 0.431 μm or more.

From the above, it was found that the cutting tool 100 according to the example can reduce the surface roughness of the processed surface of the workpiece as compared with the cutting tool 100 according to the comparative example. According to the cutting tool 100 of the example, it is considered that the vibration of the cutting tool 100 during cutting was reduced by improving the rigidity of the main body 3. Thus, it is considered that the processed surface of the workpiece could be smoothly finished.

### Example 2

### <Sample Preparation>

Next, the roughness of the processed surfaces was investigated in the case where the diameter D1 of the main body 3 was 2.5 mm. The cutting tools 100 according to samples 2-1 to 2-5 were prepared. The cutting tool 100 according to samples 2-1 to 2-3 were examples. The cutting tool 100 according to samples 2-4 and 2-5 were comparative examples. The manufacturing method of the cutting tool 100 according to samples 2-1 to 2-5 was substantially the same as the manufacturing method of the cutting tool 100 according to samples 1-1 to 1-5 described above.

TABLE 3

| | Material of Main Body | | | | |
|---|---|---|---|---|---|
| | WC | Co | Diameter | | |
| | Content | Content | of Main | | |
| | Rate | Rate | Body | First | Third |
| | (%) | (%) | (mm) | Angle | Angle |
| Sample 2-1 | 92 | 8 | 2.5 | 3° | 10° |
| Sample 2-2 | 94 | 5 | | | |
| Sample 2-3 | 94 | 5.4 | | | |
| Sample 2-4 | 88 | 12 | | | |
| Sample 2-5 | 89 | 6 | | | |

Table 3 shows the configuration of the cutting tool 100 according to samples 2-1 to 2-5. As shown in table 3, in samples 2-1 to 2-3, the WC content rate was 92% to 94%. The Co content rate was 5% to 8%. In the samples 2-4 and 2-5, the WC content rate was 89% or less. In sample 2-4, the Co content rate was 12%. In the sample 2-5, the Co content rate was 6%.

In samples 2-1 to 2-5, the cutting edge layer 4 was formed of nano polycrystalline diamond. The binder content rate of the polycrystalline diamond forming the cutting edge layer 4 was 0%. The diameter of the main body 3 was 2.5 mm. The first angle θ1 was 3°. The clearance angle (third angle θ3) was 10°.

### <Evaluation Method>

The following cutting evaluation was performed using the cutting tools 100 according to samples 2-1 to 2-5. Specifically, the cutting tool 100 was attached to the turret of an NC lathe. A cylindrical workpiece was fixed to the chuck of an NC lathe. Turning was performed on the workpiece using the following cutting conditions.

### <Cutting Conditions>

Workpiece: Cemented carbide (hardness: HRA88.0, outside diameter: 30 mm, inside diameter: 5 mm, total length: 13 mm)
Cutting speed (Vc): 10 m/min
Depth of cut (ap): 0.025 mm
Feed per revolution (f): 0.04 mm/rev
Overhang length: 15 mm
Cutting oil material: None (dry processing)

In the turning, the roughness (Rz and Ra) of the processed surfaces of the workpieces was measured at the time when the cut length reached 5.6 m. Rz and Ra were measured in accordance with JIS B 0601:2001 using a surface roughness measuring device.

### <Evaluation Result>

TABLE 4

Surface Roughness of
Processed Surface

| | Rz | Ra |
|---|---|---|
| | (μm) | (μm) |
| Sample 2-1 | 2.02 | 0.407 |
| Sample 2-2 | 1.064 | 0.18 |
| Sample 2-3 | 1.866 | 0.39 |
| Sample 2-4 | 3.294 | 0.717 |
| Sample 2-5 | 2.785 | 0.591 |

Table 4 shows the evaluation results of the samples 2-1 to 2-5. As shown in table 4, in samples 2-1 to 2-3, Rz of the processed surface was 2.02 μm or less. Ra of the processed surface was 0.407 μm or less. In samples 2-4 and 2-5, the Rz of the processed surface was 2.785 μm or more. Ra of the processed surface was 0.591 μm or more.

From the above, it was found that the cutting tool 100 according to the example can reduce the surface roughness of the processed surface of the workpiece as compared with the cutting tool 100 according to the comparative example. According to the cutting tool 100 of the example, it is considered that the vibration of the cutting tool 100 during cutting was reduced by improving the rigidity of the main body 3. Thus, it is considered that the processed surface of the workpiece could be smoothly finished.

### Example 3

### <Sample Preparation>

Next, the influence of the composition of the main body 3 on the transverse rupture strength of the main body was investigated. The cutting tools 100 according to samples 3-1 to 3-3 were prepared. The cutting tool 100 according to samples 3-1 and 3-2 were examples. The cutting tool 100 according to sample 3-3 were comparative examples. The manufacturing method of the cutting tool 100 according to samples 3-1 to 3-3 was substantially the same as the manufacturing method of the cutting tool 100 according to samples 1-1 to 1-5 described above.

TABLE 5

| | Material of Main Body | | | | |
|---|---|---|---|---|---|
| | WC | Co | Diameter | | |
| | Content | Content | of Main | | |
| | Rate | Rate | Body | First | Third |
| | (%) | (%) | (mm) | Angle | Angle |
| Sample 3-1 | 92 | 8 | 2.5 | 3° | 10° |
| Sample 3-2 | 94 | 5 | | | |
| Sample 3-3 | 99 | 0.7 | | | |

Table 5 shows the configuration of the cutting tool 100 according to samples 3-1 to 3-3. As shown in table 5, in samples 3-1 and 3-2, the WC content rate was 92% to 94%. The Co content rate was 5% to 8%. In the sample 3-3, the WC content rate was 99%. The Co content rate was 0.7%.

In samples 3-1 to 3-3, the cutting edge layer 4 was formed of nano polycrystalline diamond. The binder content rate of the polycrystalline diamond forming the cutting edge layer 4 was 0%. The diameter of the main body 3 was 2.5 mm. The first angle θ1 was 3°. The clearance angle (third angle θ3) was 10°.

### <Evaluation Method>

The following cutting evaluation was performed using the cutting tools 100 according to samples 3-1 to 3-3. Specifically, the cutting tool 100 was attached to the turret of an NC lathe. A cylindrical workpiece was fixed to the chuck of an NC lathe. Turning was performed on the workpiece using the following cutting conditions.

### <Cutting Conditions>

Workpiece: Cemented carbide (hardness: HRA88.0, outside diameter: 30 mm, inside diameter: 5 mm, total length: 25 mm)
Cutting speed (Vc): 10 m/min
Depth of cut (ap): 0.05 mm
Feed per revolution (f): 0.1 mm/rev
Overhang length: 27 mm
Cutting oil material: None (dry processing)

In the turning, the roughness (Rz and Ra) of the processed surfaces of the workpieces was measured at the time when the cut length reached the 1 km. Rz and Ra were measured in accordance with JIS B 0601:2001 using a surface roughness measuring device.

At the time when the cut length reached 1 km, the flank face wear width (maximum flank face wear width) at the cutting edge portion corresponding to the position where the depth of cut of the workpiece was maximum was measured. The position where the cut of the workpiece is the largest is the position of the cutting edge 10 where the distance between the axis X and the cutting edge 10 in the second direction 102 is the largest. The flank face wear width is a width in the third direction 103 of a portion of the flank face where wear is found. It is understood that the smaller the numerical value of the maximum flank face wear width, the higher the wear resistance at the cutting edge portion corresponding to the position where the depth of cut of the workpiece is the maximum.

### <Evaluation Result>

TABLE 6

| | |
|---|---|
| Maximum | Surface Roughness of |
| Flank Face | Processed Surface |

| | Wear Width | Rz | Ra |
|---|---|---|---|
| | (μm) | (μm) | (μm) |
| Sample 3-1 | 13.03 | 4.012 | 0.941 |
| Sample 3-2 | 14.65 | 3.908 | 0.881 |
| Sample 3-3 | Broken | | |

Table 6 shows the evaluation results of the samples 3-1 to 3-3. As shown in table 6, in samples 3-1 and 3-2, the maximum flank face wear width was 14.65 μm or less. Rz of the processed surface was 4.012 μm or less. Ra of the processed surface was 0.941 μm or less. In the sample 3-3, the main body 3 was broken in the process of the cutting, and thus the above-described turning was stopped. In sample 3-3, thus, the maximum flank face wear width, the Rz of the processed surface, and the Ra of the processed surface could not be measured. In samples 3-1 and 3-2, no breakage of the main body 3 was found.

As described above, it was found that the cutting tool 100 according to the example can prevent the main body 3 from being broken, as compared with the cutting tool 100 according to the comparative example. From another viewpoint, it was found that the cutting tool 100 according to the example can reduce an excessive decrease in the transverse rupture strength of the main body 3. When the Co content rate is 0.7% or less, the transverse rupture strength of the main body 3 is excessively reduced, making it unsuitable for the above-described turning.

### Example 4

### <Sample Preparation>

Next, the influence of the first angle θ1 on the surface roughness of the processed surface and the influence of the third angle θ3 on the maximum flank face wear width were investigated. The cutting tools 100 according to samples 4-1 to 4-4 were prepared. The cutting tool 100 according to samples 4-1 to 4-4 were examples. The manufacturing method of the cutting tool 100 according to samples 4-1 to 4-4 was substantially the same as the manufacturing method of the cutting tool 100 according to samples 1-1 to 1-5 described above.

TABLE 7

| | Material of Main Body | | | | |
|---|---|---|---|---|---|
| | WC | Co | Diameter | | |
| | Content | Content | of Main | | |
| | Rate | Rate | Body | First | Third |
| | (%) | (%) | (mm) | Angle | Angle |
| Sample 4-1 | 92 | 8 | 3.5 | 3° | 10° |
| Sample 4-2 | | | | 3° | 7° |
| Sample 4-3 | | | | 3° | 13° |
| Sample 4-4 | | | | 5° | 10° |

Table 7 shows the configuration of the cutting tool 100 according to samples 4-1 to 4-4. As shown in table 7, in samples 4-1 to 4-3, the first angle θ1 was 3°. The clearance angle (third angle θ3) was 7° to 13°. In the sample 4-4, the first angle θ1 was 5°. The clearance angle (third angle θ3) was 10°.

In the samples 4-1 to 4-4, the WC content rate was 92%. The Co content rate was 8%. In samples 4-1 to 4-4, the cutting edge layer 4 was formed of nano polycrystalline diamond. The binder content rate of the polycrystalline diamond forming the cutting edge layer 4 was 0%. The diameter of the main body 3 was 3.5 mm.

### <Evaluation Method>

The following cutting evaluation was performed using the cutting tools 100 according to samples 4-1 to 4-4. Specifically, the cutting tool 100 was attached to the turret of an NC lathe. A cylindrical workpiece was fixed to the chuck of an NC lathe. Turning was performed on the workpiece using the following cutting conditions.

### <Cutting Conditions>

Workpiece: Cemented carbide (hardness: HRA88.0, outside diameter: 30 mm, inside diameter: 5 mm, total length: 18 mm)
Cutting speed (Vc): 10 m/min
Depth of cut (ap): 0.025 mm
Feed per revolution (f): 0.04 mm/rev
Overhang length: 20 mm
Cutting oil material: None (dry processing)

In the turning, the roughness (Rz and Ra) of the processed surfaces of the workpieces was measured at the time when the cut length reached the 1 km. Rz and Ra were measured in accordance with JIS B 0601:2001 using a surface roughness measuring device. The maximum flank face wear width was measured at the point where the cut length reached the 1 km.

### <Evaluation Result>

TABLE 8

| | |
|---|---|
| Maximum | Surface Roughness of |
| Flank Face | Processed Surface |

| | Wear Width | Rz | Ra |
|---|---|---|---|
| | (μm) | (μm) | (μm) |
| Sample 4-1 | 17.2 | 1.796 | 0.337 |
| Sample 4-2 | 23.2 | 2.017 | 0.372 |
| Sample 4-3 | 14.7 | 1.891 | 0.348 |
| Sample 4-4 | 16.6 | 2.322 | 0.469 |

Table 8 shows the evaluation results of samples 4-1 to 4-4. As shown in table 8, in samples 4-1 to 4-3, Rz of the processed surface was 2.017 μm or less. Ra of the processed surface was 0.372 μm or less. In sample 4-4, the Rz of the processed surface was 2.322 μm. Ra of the processed surface was 0.469 μm. In samples 4-1 to 4-4, the maximum flank face wear width was 14.7 μm to 23.2 μm.

From the above, it was found that the surface roughness of the processed surface of the workpiece can be reduced according to the samples (samples 4-1 to 4-3) in which the first angle θ1 is 3°, compared to the sample (sample 4-4) in which the first angle θ1 is 5°. In the cutting tool 100 according to samples 4-1 to 4-3, it is considered that the processed surface of the workpiece could be smoothly processed because the length of the first cutting edge portion 6 in contact with the workpiece was long. It was also found that the maximum flank face wear width is reduced as the third angle θ3 is larger.

### Example 5

### <Sample Preparation>

Next, the influence of the binder content rate of the polycrystalline diamond forming the cutting edge layer 4 on the maximum flank face wear width and the surface roughness of the processed surface was investigated. The cutting tools 100 according to samples 5-1 to 5-3 were prepared. The cutting tool 100 according to samples 5-1 to 5-3 were examples.

The manufacturing method of the cutting tool 100 according to sample 5-1 was substantially the same as the manufacturing method of the cutting tool 100 according to samples 1-1 to 1-5 described above. The manufacturing method of cutting tool 100 according to samples 5-2 and 5-3 was substantially the same as the manufacturing method of cutting tool 100 according to samples 1-1 to 1-5 described above except for the method of processing polycrystalline diamond. Specifically, in sample 5-2 and sample 5-3, cutting edge layer 4 was formed by processing polycrystalline diamond using grinding.

TABLE 9

| | Material of Cutting | Material of Main Body | | | | |
|---|---|---|---|---|---|---|
| | Edge Layer | WC | Co | | | |
| | Binder | Content | Content | Diameter of | | |
| | Content Rate | Rate | Rate | Main Body | First | Third |
| | (%) | (%) | (%) | (mm) | Angle | Angle |
| Sample | 0 | 92 | 8 | 3.5 | 3° | 10° |
| 5-1 | | | | | | |
| Sample | 10 | | | | | |
| 5-2 | | | | | | |
| Sample | 15 | | | | | |
| 5-3 | | | | | | |

Table 9 shows the configuration of the cutting tool 100 according to samples 5-1 to 5-3. As shown in table 9, in sample 5-1, the binder content rate was 0%. In the sample 5-2, the binder content rate was 10%. In the sample 5-3, the binder content rate was 15%. In sample 5-1, the cutting edge layer 4 was formed of nano polycrystalline diamond. In samples 5-2 and 5-3, the cutting edge layer 4 was formed of polycrystalline diamond.

In the samples 5-1 to 5-3, the WC content rate was 92%. The Co content rate was 8%. The diameter of the main body 3 was 3.5 mm. The first angle θ1 was 3°. The clearance angle (third angle θ3) was 10°.

### <Evaluation Method>

The following cutting evaluation was performed using the cutting tools 100 according to samples 5-1 to 5-3. Specifically, the cutting tool 100 was attached to the turret of an NC lathe. A cylindrical workpiece was fixed to the chuck of an NC lathe. Turning was performed on the workpiece using the following cutting conditions.

### <Cutting Conditions>

Workpiece: Cemented carbide (hardness: HRA88.0, outside diameter: 30 mm, inside diameter: 5 mm, total length: 18 mm)
Cutting speed (Vc): 10 m/min
Depth of cut (ap): 0.025 mm
Feed per revolution (f): 0.04 mm/rev
Overhang length: 20 mm
Cutting oil material: None (dry processing)

In the turning, the roughness (Rz and Ra) of the processed surfaces of the workpieces was measured at the time when the cut length reached 16.8 m. Rz and Ra were measured in accordance with JIS B 0601:2001 using a surface roughness measuring device. The maximum flank face wear width was measured at the point where the cut length reached the 16.8 m.

### <Evaluation Result>

TABLE 10

| | |
|---|---|
| Maximum | Surface Roughness of |
| Flank Face | Processed Surface |

| | Wear Width | Rz | Ra |
|---|---|---|---|
| | (μm) | (μm) | (μm) |
| Sample 5-1 | 7.04 | 1.988 | 0.366 |
| Sample 5-2 | 22.86 | 3.886 | 0.646 |
| Sample 5-3 | 171.8 | 15.662 | 2.448 |

Table 10 shows the evaluation results of samples 5-1 to 5-3. As shown in table 10, in samples 5-1 and 5-2, the maximum flank face wear width was 22.86 μm or less. In sample 5-3, the maximum flank face wear width was 171.8 μm.

In samples 5-1 and 5-2, the Rz of the processed surface was 3.886 μm or less. Ra of the processed surface was 0.646 μm or less. In sample 5-3, the Rz of the processed surface was 15.662 μm. Ra of the processed surface was 2.448 μm.

From the above, it was found that, compared to the sample (sample 5-3) having a binder content rate of 15%, the samples (samples 5-1 and 5-2) having a binder content rate of 10% or less can improve the wear resistance of the cutting edge layer 4 and reduce the surface roughness of the processed surface of the workpiece. It is considered that in samples 5-1 and 5-2, the wear resistance of the cutting edge layer 4 was improved due to the improvement in the hardness of the cutting edge layer 4. Thus, it is considered that the maximum flank face wear width was reduced. Thus, the cutting tool 100 according to samples 5-1 and 5-2 can perform cutting for a longer time than the cutting tool 100 according to sample 5-3.

In each of example 1 to example 5, the composition of the hard phase in the cemented carbide forming the main body 3 was examined by X-ray diffraction, and it was found that the hard phase of all the samples was substantially composed of WC grains.

The embodiments and examples disclosed herein are to be considered in all respects as illustrative and not restrictive. The scope of the present invention is defined not by the above description but by the appended claims, and is intended to include any modifications within the scope and meaning equivalent to the scope of the claims.

### REFERENCE SIGNS LIST

1 front end, 2 rear end, 3 main body, 4 cutting edge layer, 5 brazing material, 6 first cutting edge portion, 7 second cutting edge portion, 8 corner cutting edge portion, 10 cutting edge, 11 rake face, 12 first flank face, 13 corner flank face, 14 third flank face, 18 curved face, 19 second flank face, 21 first front end face portion, 22 second front end face portion, 31 seat face, 32 sidewall face, 33 outer peripheral face, 34 front end face, 36 flat face portion, 37 curved face portion, 39 depression, 41 bottom face, 42 side face, 51 first portion, 52 second portion, 81 first end point, 82 second end point, 91 first imaginary straight line, 92 second imaginary straight line, 93 third imaginary straight line, 94 fourth imaginary straight line, 95 imaginary plane, 97 inner peripheral surface, 98 processed surface, 99 workpiece, 100 cutting tool, 101 first direction, 102 second direction, 103 third direction, 200 machine tool, A, B, F arrow, C central axis, D1 diameter, D2 inside diameter, H width, L1 length, L2 overhang length, X axis, ap depth of cut, θ1 first angle, θ2 second angle, θ3 third angle, θ4 fourth angle, θ5 fifth angle.

1. A cutting tool comprising:
a main body having a rod shape; and
a cutting edge layer disposed at a front end of the main body and forming a cutting edge,
wherein the main body is formed of a cemented carbide containing tungsten carbide and cobalt,
the cutting edge layer is formed of polycrystalline diamond, and
in the cemented carbide,
a percentage of a value obtained by dividing a weight of the tungsten carbide by a weight of an entirety of the cemented carbide is 90.0% to 95.0%,
a percentage of a value obtained by dividing a weight of the cobalt by the weight of the entirety of the cemented carbide is 4.0% to 9.0%,
the main body has a diameter of 6 mm or less,
a length of the main body in a direction from the front end toward a rear end along an axis of the main body is 30 mm or more,
the cutting edge has
a corner cutting edge portion having a first end point and a second end point opposite to the first end point,
a first cutting edge portion connected to the corner cutting edge portion at the first end point and provided at a position in the direction from the front end toward the rear end along the axis of the main body with respect to the corner cutting edge portion, and
a second cutting edge portion connected to the corner cutting edge portion at the second end point and provided at a position in a direction from the corner cutting edge portion toward the axis with respect to the corner cutting edge portion,
the cutting edge layer has a first flank face connected to the first cutting edge portion,
when viewed in a direction in which the first cutting edge portion extends,
the first flank face is inclined, with respect to an imaginary straight line perpendicular to an imaginary plane including the corner cutting edge portion and the first cutting edge portion and crossing the first cutting edge portion, in a direction from the first cutting edge portion toward the axis, and
an angle formed by the imaginary straight line and the first flank face is 7° to 13°,
when viewed in the direction perpendicular to the imaginary plane,
the first cutting edge portion is inclined with respect to the axis in a direction from the first end point toward the axis with the first end point serving as a fulcrum, and
an angle formed by the axis and the first cutting edge portion is 2° to 4°,
the cutting edge layer has a second flank face connected to the first flank face and located opposite to the first cutting edge portion with respect to the first flank face,
when viewed in the direction in which the first cutting edge portion extends,
the second flank face is inclined with respect to the imaginary straight line in the direction from the first cutting edge portion toward the axis, and
an angle formed by the imaginary straight line and the second flank face is 20° or more, and
a width of the first flank face in a direction in which the imaginary straight line extends is 0.4 mm or less.

2. The cutting tool according to claim 1, wherein, in the cemented carbide, the percentage of the value obtained by dividing the weight of the cobalt by the weight of the entirety of the cemented carbide is 5.0% to 8.0%.

3. The cutting tool according to claim 1,
wherein the polycrystalline diamond includes a plurality of diamond grains, and
in the polycrystalline diamond, a percentage of a value obtained by dividing a weight of a binder binding the plurality of diamond grains together by a weight of an entirety of the polycrystalline diamond is 10.0% or less or 0%.

4. The cutting tool according to claim 3, wherein, in the polycrystalline diamond, the percentage of the value obtained by dividing the weight of the binder by the weight of the entirety of the polycrystalline diamond is 1.0% or less or 0%.

5. (canceled)

6. The cutting tool according to claim 1, comprising a brazing material joining the cutting edge layer and the main body together,
wherein the brazing material contains silver, copper, and titanium.

7. (canceled)

8. (canceled)
